(19) United States
(12) Patent Application Publication
(10) Pub. No.: US 2026/0277704 A1
(43) Pub. Date: Sep. 17, 2026

(54) SLA-DRIVEN ORCHESTRATION OF SOFTWARE CONTAINERS

(71) Applicant: Nokia Solutions and Networks Oy, Espoo (FI)

(72) Inventors: Catello DI MARTINO, Sao Paulo (BR); Marco BARLETTA, Stuttgart (DE)

(21) Appl. No.: 19/157,939

(22) PCT Filed: Feb. 21, 2023
(86) PCT No.: PCT/EP2023/054281

§ 371 Date: Aug. 19, 2025

(51) Int. Cl. G06F 9/50; G06F 21/53

(52) U.S. Cl. CPC G06F 9/5088; G06F 21/53; G06F 2221/033

(57) ABSTRACT

Described herein is An apparatus for controlling a plurality of working nodes on which applications providing services are running, said apparatus comprising a network orchestration unit, a detection and prediction unit and a migration handling unit, wherein: said network orchestration unit is configured to monitor said plurality of working nodes and configure network resources for said plurality of working nodes; said detection and prediction unit is configured to detect or predict a Service Level Agreement, SLA, violation at a target node comprised in said plurality of working nodes; and said migration handling unit is configured to trigger migration of a target service provided by a target application running on said target node to a destination node, in a case where a time to violation related to said predicted or detected SLA violation is less than a duration of a migration sensitive window related to said migration.

### TECHNOLOGY

The present disclosure relates to orchestration of network resources in a mutating network environment, and in particular to an adaptive orchestration for preventing violations of Service Level Agreements.

### BACKGROUND

Any discussion of the background art throughout the specification should in no way be considered as an admission that such art is widely known or forms part of common general knowledge in the field.

The continuous reconfiguration of the factory floor is one of the key prerequisites of the vision of Industry 4.0 (14.0). To address flexible market demands and mutating business goals a progressive softwarization of industrial components is needed, which however introduces new challenges, due to the inherent software propensity to failure and the strict mandatory regulations.

Nevertheless, to meet both functional and non-functional requirements dictated by the goals of the factory, networking and computing resources must be managed to minimize the Service Level Agreement (SLA) violations.

Orchestration systems manage the lifecycle of the software containers to deploy it exactly where and when is needed to respect the SLA. Currently available orchestration systems are tailored for containers in cloud environments, and they need a complete redesign to meet 14.0 requirements, with an intelligent placement that considers network resources and SLAs.

In particular, the placement is not currently criticality-aware (aware of potential consequences of failures and SLA violations) and overlooks SLA parameters related to networks. For example, if a fleet manager in a production line fails to deliver its command on-time to moving robots, and its services are not properly reconfigured on time by the orchestrator, a robot can go out of control and hurt nearby workers. A fleet manager is a software component in charge of deciding the path of the moving robots in order to avoid collisions, communicating the points on the path to the robots. A robot out of control would require: 1) an automatic reboot of its on-board computer which takes approximately 5 minutes, or 2) a manual intervention which could take up to 20 minutes. These downtimes are unacceptable as they severely impact the goals of the factory.

When an SLA violation is predicted, migrating a service elsewhere where the SLA is respected is a promising option, due to the high number of nodes in the environment.

Anyway, migrating critical services like industrial control loops needs additional precaution: a suitable destination node must be selected, and network and computing resources must be reconfigured to both minimize the probability of SLA violation and reduce the downtime. In industry verticals, even sub-second downtimes can lead the whole system to major outages and severe consequences.

Coming back to the fleet manager example, once the latency failure is detected, it might be moved as close as possible to the production line to meet its expected response time and to avoid a robot misbehavior.

Further, each service might have widely varying connectivity needs expressed in specific SLAs (Service Level Agreements), expressed with mathematical relations between defined Key Performance Indicators (KPIs) and numeric thresholds.

It is critical to ensure that the migration process does not lead to unacceptable violations of the SLA (for time or values) and that after the migration the SLA can be respected. The problem is that currently the migration process does not take into account industrial SLA-related KPI in the node selection process, and if the network status changes there is no guarantee to respect the SLA. The main problem can be split in two subproblems: when to migrate a service, since currently the approach is a recovery after failure, that is after minutes of downtime; and where to migrate the service, selecting the best destination node.

Therefore, it is necessary to resolve the following issue: Given a change in the environment (e.g., failure, network degradation or movement of a connected device to a shadow area), which is the best policy for migrating a service to another place, taking into account its SLA requirements (e.g., bandwidth, latency, jitter, resiliency, availability, reliability and security and any other mission-specific KPI) in order to keep up with the requirements of the application.

In “State machine replication in containers managed by Kubernetes” (Netto, Lung, Correia, Luiz, Sá de Souza, J S A 2016) state machine replication is implemented in Kubernetes through consensus of the stateful replicas to improve the fault tolerance with regard stateful services. In “Automatic Integration of BFT State-Machine Replication into IoT Systems” (Berger, Reiser, Hauck, Held, Domaschka, EDCC 2022) a framework to integrate State-Machine Replication into k3s is proposed, stressing the event-driven interaction model over a client-server model, a building-block principle and automatic deployment of the replicas. However, in both of the papers, there is no focus on criticality, migration and industrial environment.

In U.S. Pat. No. 10,776,244B2, a method of modeling a prospective systems migration between server systems is provided. The method comprises: detecting, by a remote system, that a gateway is not yet installed on a first server system and, consequent to the detecting, initiating the gateway on the first server system at least in part to operate as a control point on the first server system that provides access and access security to a second server system and provides services to migrate applications from the first server system to the second server system. However, the method does not include a clear strategy on the decision time and a place for the migration.

In “Proactive Virtual Machine Migration in Fog Environments” (Goncalves, Velasquez, Curado, Bittencourt and Madeira, ISCC 2018), a VM (Virtual Machine) migration approach based on mobility prediction is proposed. It uses an ILP model with prediction-based future data of the VM to minimize a generic cost function, and communication latency with the user in Fog Cloud is taken as example. However there is no decision process for migration time, and there is no relation with SLA levels, criticality and fault tolerance.

In view of the above, it is necessary to provide pre-emptive mitigation of SLA violations with the best policy in terms of the timing of the mitigation and the mitigation (hardware and time) costs. In particular, it is necessary to provide, in addition to in-place mitigation as a countermeasure taken for instance after detecting an SLA violation, an adaptive migration of the relevant service to a most suitable destination node, taking into consideration the criticality level of the service.

### SUMMARY

In accordance with an aspect of the present disclosure, there is provided an apparatus for controlling a plurality of working nodes on which applications providing services are running, said apparatus comprising a network orchestration unit, a detection and prediction unit and a migration handling unit, wherein:
said network orchestration unit is configured to monitor said plurality of working nodes and configure network resources for said plurality of working nodes;
said detection and prediction unit is configured to detect or predict a Service Level Agreement, SLA, violation at a target node comprised in said plurality of working nodes; and
said migration handling unit is configured to trigger migration of a target service provided by a target application running on said target node to a destination node, in a case where a time to violation related to said predicted or detected SLA violation is less than a duration of a migration sensitive window related to said migration.

In some examples, said migration handling unit is configured to trigger said migration, in a case where said time to violation is larger than a duration of an in-place mitigation window related to in-place mitigation of said detected or predicted SLA violation.

In some examples, said migration handling unit is configured to trigger in-place mitigation of said detected or predicted SLA violation, in a case where said time to violation is less than a duration of an in-place mitigation window related to said in-place mitigation.

In some examples, said duration of said migration sensitive window equals to an estimated migration time multiplied by a criticality factor, and the criticality factor is related to a critical level of said target service.

In some examples, a value of said criticality factor increases for critical levels in the order of a first critical level, a second critical level, a third critical level and a fourth critical level, and the apparatus comprises a criticality managing unit configured to record and output said critical levels.

In some examples, for a first critical level:
said network orchestration unit is configured to generate, at said destination node, a replica for said target service, preferably at the time of detecting or predicting said SLA violation;
and said migration handling unit is configured to migrate said target service to said destination node.

In some examples, for a second critical level:
said network orchestration unit is configured to generate, at said destination node, a cold spare replica for said target service; and
said migration handling unit is configured to activate said cold spare replica, preferably at the time of detecting or predicting an SLA violation at said destination node, and to migrate said target service from said target node to a node comprised in said plurality of nodes that is different from said destination node.

In some examples, said network orchestration unit is configured to: in a case where said destination node is not able to mitigate said SLA violation within said estimated migration time, send a delay instruction to said target node for delaying said target service.

In some examples, said network orchestration unit is configured to, for a third critical level:
configure said target node as a master node for said target service and generate, at said destination node, a hot spare replica for said target service, if an SLA violation is not yet detected or predicted at said target node; and
configure said destination node as the master node for said target service and configure said target node as the hot spare replica, if an SLA violation is detected or predicted.

In some examples, said network orchestration unit is configured to, for a fourth critical level:
in a case of said detected SLA violation being a violation of a safe state, replace said application running on said target node with a safe container for returning to the safe state.

In some examples, said SLA comprises mathematical and statistical relations between Key Performance Indicators, KPIs, and numeric KPI thresholds specified for said plurality of nodes.

In some examples, said migration handling unit is configured to obtain said time to violation for said target node on the basis of a regression model established for sampled KPIs related to said target node, wherein said time to violation is computed as the time after said regression model intersects with one or more of KPI thresholds specified for said target node.

In some examples, said prediction and detection unit is configured to predict and/or detect said SLA violation based on sampled values of KPIs of said plurality of nodes.

In some examples, said apparatus further comprises a score ranking unit: configured to calculate a score for each of said plurality of nodes and SLAs related to said each node; rank said plurality of nodes based on calculated scores; and said criticality managing unit is configured to check said plurality of scored nodes starting from the highest ranking node in an order of decreasing score, determine if a node has a score that is greater than said target node by at least a pre-determined threshold value, and select said node as the destination node.

In some examples, the apparatus is configured for managing factory related networking and computing resources and/or for managing a production line to deliver commands on-time to e.g., (moving, or static, or semi-static) industrial components.

In accordance with another aspect of the present disclosure, there is provided a method, carried out by an apparatus for controlling a plurality of working nodes on which applications providing services are running, said apparatus comprising a network orchestration unit, a detection and prediction unit and a migration handling unit, wherein the method comprises:
monitoring, by said network orchestration unit, said plurality of working nodes and configure network resources for said plurality of working nodes;
detecting or predicting, by said detection and prediction unit, a Service Level Agreement, SLA, violation at a target node comprised in said plurality of working nodes; and
triggering, by said migration handling unit, migration of a target service provided by a target application running on said target node to a destination node, in a case where a time to violation related to said predicted or detected SLA violation is less than a duration of a migration sensitive window related to said migration.

In accordance with another aspect of the present disclosure, there is provided a system comprising said apparatus, and a plurality of working nodes controlled by said apparatus,
wherein each node comprises a KPI sampling unit configured to collect sampled KPI values for KPIs specified in SLAs for said each node, and to provide said collected values to said apparatus.

In some examples, said apparatus and said plurality of working nodes are configured in the Cloud.

According to some example embodiments, there is also provided a computer program comprising instructions for causing an apparatus to perform the method as disclosed in the present disclosure.

According to some example embodiments, there is also provided a memory storing computer readable instructions for causing an apparatus to perform the method as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example diagram of an mitigation flow;

FIG. 2 schematically illustrates an example estimation of the mitigation time;

FIG. 3 schematically illustrates an example of SLA violation prediction algorithm;

FIGS. 4 and 5 schematically illustrate examples of estimation of the migration time for different levels of SLA criticality;

FIG. 6 schematically illustrates an example architecture of the orchestration system;

FIG. 7 schematically illustrates an example of a use case for the Performance SLA level;

FIG. 8 schematically illustrates an example of a use case for the High-availability SLA level;

FIG. 9 schematically illustrates an example of a use case for the Resiliency SLA level; and

FIG. 10 schematically illustrates an example of a use case for the Safety SLA level.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may be omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

References are now made to the figures. In particular, it is to be noted that identical or like reference numbers used in the figures of the present disclosure may, unless indicated otherwise, indicate identical or like elements, such that repeated description thereof may be omitted for reasons of conciseness. It is further to be noted that, as can be understood and appreciated by the skilled person, even though the figures may appear to make reference to some specific/explicit message names/types, these messages may certainly, depending on various implementations (e.g., the underlining technologies), have different names and/or be communicated/exchanged in different forms/formats.

Orchestration systems are distributed systems in charge of automatically placing, deploying, monitoring, and migrating the packaged software (e.g., containers) across the computing infrastructure, behaving as cloud operating systems. An orchestration system is composed of a control plane and a compute cluster. The former receives requests for deployment, monitors the state of applications, and manages the lifecycle of the packaged software. The compute cluster is composed of worker nodes on which the packaged applications are deployed (according to e.g., M. A. Rodriguez and R. Buyya, “Container-Based Cluster Orchestration Systems: A Taxonomy and Future Directions,” Wiley Software: Practice and Experience, 2019.). On a deployment request, the control plane places the applications on the worker nodes through a scheduling process. The orchestration system reacts accordingly when the current state diverges from the desired steady state. For example, the desired steady state of an application requires three load-balanced replicas of a service, but one is not responding. A replacement is spawned on a different worker node, and the resources of the failed replica are released. This process, heron called migration, requires additional care for stateful services.

In the present disclosure, migration of a service includes the generation of a replica at a working node (or a worker node, used interchangeably) selected as a destination node for (re-)spawning the service which is previously provided at another node where an SLA violation is detected or predicted. This process involves possibly reservation of relevant resources at the destination node by the network orchestration system or platform.

Preferably, as long as the service (or interchangeably the software application providing the service) is stateless (i.e., does not hold any status), migration of a service refers to migration of software application(s) providing the to-be-migrated service. In case of a stateful service, the migration comprises respawning the service, and more preferably that the memory of the running service is physically copied from the previous node to the destination node.

The objective of the present disclosure is to ensure an SLA-aware migration of services in e.g., a mutating factory floor, based on numerical KPIs.

The decision process decides when to trigger the migration of a service to reduce the downtime.

The present disclosure includes the elements as described in the following.
1. A differentiated mitigation approach for SLA violation based on the SLA criticality level;
2. An algorithm/method to select the time window during which a migration is convenient with a little or no disruption of the service. The algorithm is based on migration estimation time and can be fine-tuned on the base of several parameters such as:
   a. a time offset to guarantee enough margin to avoid downtimes,
   b. an hysteresis parameter to guarantee stability to the algorithm,
   c. a gain threshold to avoid migration between comparable nodes,
   d. mission-critical requirements;
3. An algorithm/method to choose the most suitable destination node where to migrate one or more service replicas characterized by a scoring function with configurable weights. The destination node is selected basing on:
   a. the cost of the migration (in terms of time),
   b. the status of occupancy of the destination node,
   c. the number and position of clients served,
   d. availability of access technology on the destination node (e.g., WIFI, private/public LTE, Multifire, and 5G),
   e. status of the overall network;
4. An architecture that embodies the previous approaches and algorithms for an automatic management of resources.

The present disclosure relies on the following assumptions:
i) there are multiple nodes in different places and with different amount and types of resources controlled by an orchestration system (e.g. Kubernetes, Docker etc.),
ii) there are frequent changes in the environment, like robot movements, new deployed services (e.g., telemetry streaming, camera feeds, process control), and resource reallocations,
iii) that a programmable framework to enable KPI-driven (e.g., latency towards a given destination, bandwidth, jitter, RSSI etc.) is available, enabling network service provisioning over multiple access interfaces,
iv) that each service has network requirements in terms of KPIs are expressed as SLA to be met at runtime, and
v) the SLA are divided in 4 levels of criticality, i.e. performance, high-availability, resiliency, safety.

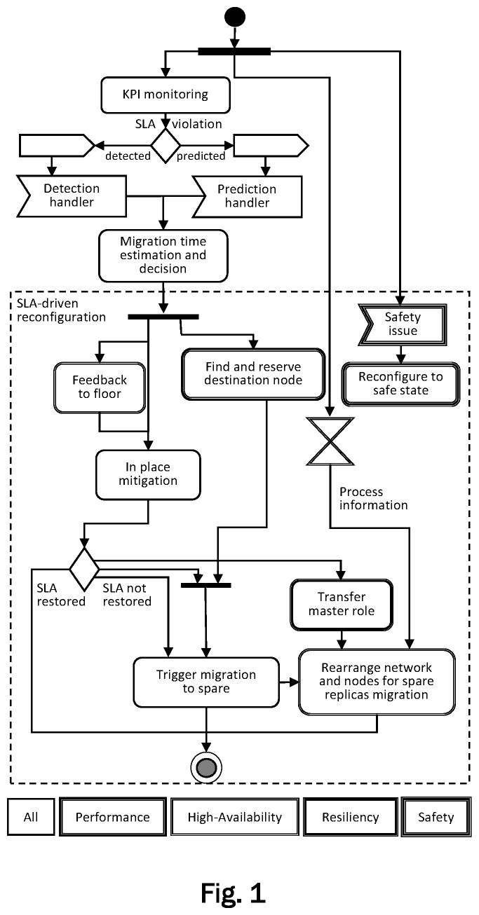

In FIG. 1 it is depicted the activity diagram of the mitigation differentiated approach provided by the present disclosure. Unless differently specified, for high-availability and higher SLA levels, the activities belong also to higher levels flows. As shown in FIG. 1, the different SLA levels are depicted with different patterns of the text frames. See in particular the different text frames shown on the bottom of FIG. 1.

I4.0 applications are usually composed of a number of services, running in one or more containers (or in general, software packaged through virtualization techniques) implementing the business logic of the use-case. Composing services belong to four levels of SLA, characterized by an increasing level of criticality described in the following.

Performance SLA: used for non-critical services where specific performances need to be guaranteed at all times, even though a temporary violation of those requirements does not cause any critical failure. In the present disclosure, the Performance SLA level is also referred to as the first critical level.

High-availability SLA: required by the services that can experience SLA violations but only for a negligible duration (e.g., 1 minute) over the course of a given time window (e.g., 1 month). The downtime must be reduced through redundancy techniques like cold-spare replication. In the present disclosure, the High-availability SLA level is also referred to as the second critical level.

Resiliency SLA: required by services that cannot experience any form of SLA violations. These services can reserve resources for multiple replicas, either hot or cold, to avoid outages despite failures of any subsystem or composing element (according to e.g., J.-C. Laprie, “From Dependability to Resilience,” IEEE/IFIP Int'l. Conf. Dependable Systems and Networks, 2008.). In the present disclosure, the Resiliency SLA level is also referred to as the third critical level.

Safety SLA: required by safety-critical services, whose failure could create hazardous situations for people and/or for the environment. These services must be deployed on certified hardware, and they must be reconfigured to provide safety checks and safe stop behaviour accordingly to the nature of the use case. For instance, in the case of a malfunctioning robot, a safe stop consists in stopping any movement and in releasing the clutch in its joints. In the present disclosure, the Safety SLA level is also referred to as the fourth critical level.

The criticality level (or, the critical level, used interchangeably) in the present disclosure is “a designation of the level of assurance against failure needed for a system component” according to e.g., A. Burns and R. I. Davis, “Mixed Criticality Systems-A Review: (February 2022),” York, 2022.

The higher the criticality level of the service is, the consequences of failures related to this service would be more severe, and hence a corresponding mitigation of an SLA violation of that service should be e.g., more in advance in time with respect to the detected or predicted timing of the SLA violation. The criticality level is related to the risk, that is the probability of a failure times the damages that a failure can potentially cause.

In the present discourse, mitigation of an SLA violation comprises in-place mitigation, that is, a countermeasure which is carried out locally at the node where the SLA violation is detected or predicted. The mitigation of an SLA violation further comprises a migration of the service, whose SLA is violated, to a destination node where the SLA is complied with, wherein the migration is preferably carried out before the SLA violation is detected or takes place and more preferably already at the time of predicting the SLA violation.

The core idea of the approach proposed in the present disclosure is to mitigate SLA violations in place when possible, triggering migrations when local countermeasures are not enough to restore the SLA, with an adaptive policy for each SLA criticality level. The services are migrated and spawned elsewhere in e.g., the factory, where the SLA is respected.

The SLA in this context can be specified as a generic logical function of the conditions evaluated between the measured values of defined KPIs and specified thresholds, through a statistical and mathematical operator (e.g. (95th percentile of network latency <15 ms AND average bandwidth in the last second >10 mbit/s) OR (packets-delivered-late==0 for the last 50 packets)).

Through continuous monitoring, different kind of anomalies can be detected. For example, a temporary fault could result in a network anomaly. In this context, it is paramount to decide quickly (in the “Migration time estimation and decision” step in FIG. 1) if to apply proper in place mitigations, i.e. mitigations without migrating the container, evaluating the KPIs.

Examples of mitigations are interface switching, e.g. from 5G to Wi-Fi. On the other hand, examples of network level mitigations are slice rearrangement, network resource redistribution, antenna tilting etc.

These recovery actions could be enough to restore the SLA. On the other hand, in case of permanent faults like hardware ones to Network Interface Card (NIC), these recovery actions would be useless, and a migration would be necessary (the “Trigger migration to spare” step in FIG. 1).

Anyway, migrating critical services like industrial control loops is not a trivial task, and additional precautions are needed. In industrial contexts, there are several services that need to respect deadlines in the order of milliseconds, while anomaly detection and mitigation countermeasures can take more. Moreover, a migration takes several seconds, while the deadlines of critical services must be respected in any case. The mitigation approach depends on the criticality level because, for example, if a service is critical and has other replicas working, a costly migration can be immediately triggered without affecting the service availability, while a non-replicated service should be restored as far as possible in place, since a migration would heavily affect its availability.

In the following the differentiated approach for mitigating SLA violations is provided in connection with FIG. 1, underlining peculiar aspects of each criticality level.

### Performance SLA

Assume having an edge service that carries out some non-critical task, and an SLA violation is predicted or detected, with a response time above threshold.

Jointly with the network, node resources must be rearranged, migrating the service to the best place for respecting the response time specified in the SLA, to guarantee lower latencies.

Thus, the orchestration system reserves resources to start a replica of the service, migrating it when the replica is up. The replica may be a hot (spare) replica, or a cold (spare) replica. At this criticality level, a downtime of the service of a few seconds does not cause catastrophic failures, thus reserving resources in advance for a spare replica is not strictly necessary, causing a resource underutilization. Hence, they must be reserved as late as possible, i.e. directly when there is the SLA violation detection or prediction (the “Find and reserve destination node” step in FIG. 1).

In case of many false positives, more migration than the necessary would be triggered, degrading the QoS. On the other hand, a false negative would incur into a temporary outage. In both cases, there would be no major consequences. The SLA violation predictor can rely on more complex models than the SLA violation detector, that should be simpler to run in real-time with low overhead.

### High-Availability SLA

Migrating a service with a high-availability requirements needs a different approach with regard to the previous case. In the industrial environment the high-availability requirement can also be interpreted as a low Mean Time To Repair (MTTR) and downtime requirement, since high-availability services cannot afford a downtime of seconds. The orchestration system finds a new place for the service, rearranging computing and communication resources with the negligible or no application outage.

The major difference in the approach hence consists in the use of fault-tolerance techniques, like redundancy, to keep the availability requested by the service. Indeed, relying for example exclusively on predictions, can lead to large downtimes. The orchestration system reserves resources in advance for a cold spare replica. Since the environment continuously evolves, periodically moving the cold replica is due to ensure the lowest possible downtimes. The placement of the replica can use additional information like industrial processes information.

In case no additional information is available, the orchestration system can give a feedback to the factory floor to delay or avoid SLA violations (the “Feedback to floor” step in FIG. 1), reducing the Operational Technologies (OT) capabilities and excluding functionalities, allowing a correct placement of the spare replica. For instance, the Operational Technology entities could receive a feedback: for example a robot can slow down to save time to understand what will happen, or a robotic arm can stop, an actuator can adapt to send commands at lower sampling frequency to avoid a complete failure and so on. Summarizing: every service that interacts with the real environment can have a degraded mode in which it still works to prevent a complete failure/SLA violation.

After the migration, the network and node resources formerly allotted to the failed replica are rearranged to spawn another cold spare replica, potentially in the place of the failed one.

### Resiliency SLA

In addition to the techniques used for the high-availability SLA, hot spare replicas or other advanced techniques could be involved, e.g. dual-redundancy or Triple-Modular Redundancy (TMR) models, spread out in critical contexts. These schemes guarantee the lowest possible probability of service outage, possibly avoiding violations at all. The service must be guaranteed despite failures of components.

For example, since in a TMR the output of the service is provided by a majority voting between three replicas. If one of them fails, the service is still be guaranteed.

Hence, for this criticality level, the approach foresees that after an SLA violation detection/prediction a replica manager must take into account the failure, possibly giving up the role of master replica with hot spare replication schemes (the “Transfer master role” step in FIG. 1). Next, a rearrangement of network and computing resources is enforced to respawn a hot spare replica (or peer replica) somewhere else, where the SLA is respected (the “Rearrange network and nodes for spare replicas migration” step in FIG. 1).

However, redundancy is useful only if the replicas have no common-cause failures. Hence, during the rearrangement of resources for spawning replicas, the node selection algorithm must evaluate the common-cause failures as well.

### Safety SLA

This level of criticality is assigned to services whose misbehaviours could damage the environment and the people. All the techniques used for the Resiliency SLA are still valid. In addition, there is the concept of safe reconfiguration to prevent hazards. Through Failure Data Analysis (FDA), safe states can be identified. Through context-aware monitoring safety-critical events are detected in real-time, and the container implementing the behavior of devices must be replaced by a safe container to allow only the safe states previously identified (the “Reconfigure to safe state” step in FIG. 1). Either a safe state or a safe-stop are valid options, if identifying safe states is not feasible.

Therefore, it is achieved with the above proposed mitigation flow a combined approach of adaptive and automated mitigation using both in-place mitigation when possible and migration of the service when in-place mitigation is not sufficient in timely mitigating the violation, considering four criticality levels with an increasing criticality. This proposed approach enables selection of the best mitigation manner of the SLA violation, which also suits the criticality level of the service. As a result, the mitigation is service-oriented and efficient in terms of time and resources.

In the following, a method for migration evaluation and decision is provided, with explanations to the respective time needed for local/in-place mitigation and migration in a case of an SLA violation being detected or predicted. Example algorithms are also shown.

The aim is to have a make-before-break approach, that means to avoid SLA violations before they occur, when possible. The following inequality must hold:

$$t\_monitoring + t\_mitigation < t\_viol .$$

Therein, t_monitoring is the time needed for sampling, computing, and running anomaly detection/prediction algorithms. t_mitigation is the duration of the mitigation flow, until the SLA is restored, determining the Mean Time To Recover (MTTR). On the Right Hand Side (RHS), tviol, is the time to SLA violation, due to a fault/error propagation, or to a mutating scenario. t_monitoring is included in the Left Hand Side (LHS) because in the worst case the fault is detected at the end of monitoring window, while it is already propagating.

Breaking down the LHS:

$$t\_sampling + t\_detection + t\_decision + t\_mit + t\_node \_sel + t\_exc + t\_download + t\_act < t\_viol .$$

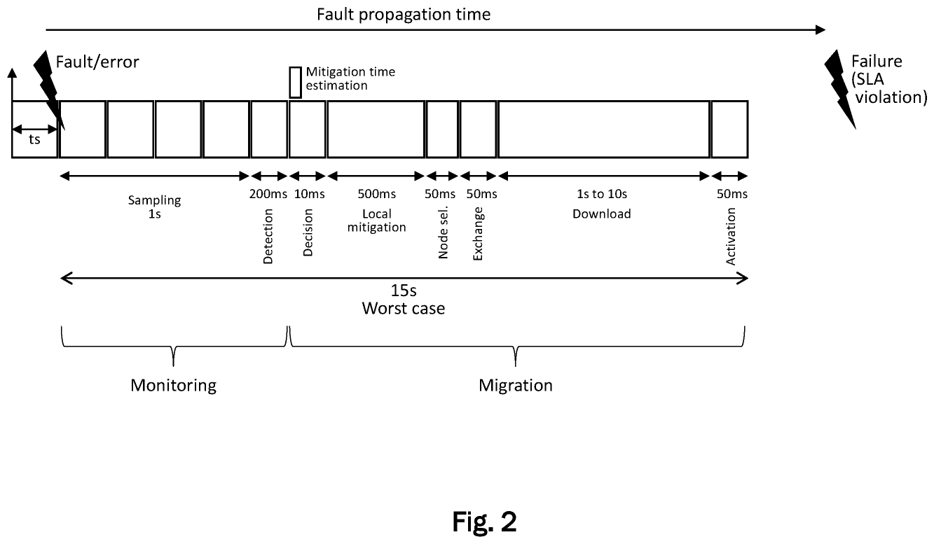

In connection with the above inequality of the LHS, FIG. 2 shows an example time estimation for mitigation in a worst case scenario where an SLA violation is detected and mitigated with both local mitigation and migration after the detection.

Therein, t_sampling is needed to collect n samples, t_detection to run the anomaly detection/prediction algorithm, t_decision to decide the mitigation to apply, t_mitigation for the duration of the local mitigation, t_node_sel to run the destination node selection algorithm, t_exc to exchange information between control plane and compute cluster, t_download to download the containers on the destination node, t_act to reserve resources and start the containers.

The decision algorithm decides when to enforce a local mitigation or to trigger a migration. t_migration must be estimated on the base of the criticality level of the service. This decision process begins with an SLA violation prediction, that generally derives from an error detection or a trend estimation. In the former case, an error is detected, like a misbehaving hardware/software component that could lead to SLA violation. In the latter case, even without faults, the mutating environment causes decreasing KPIs.

A regression coefficient for each KPI is estimated on the last n samples of the KPI values of the node. The number n of samples to take into account is computed as a function of the statistical indexes of the KPI considered, i.e. between 10 and 60 samples, with more samples if the R\hat{ }2 index is far from 1. The regression model used is the linear model because is simple enough to be run periodically at high frequencies, which are needed in industrial scenarios. If the regression line will intersect one of the KPI thresholds specified in the SLA

such that the logical function of the entire SLA does not hold anymore, i.e. a SAT solver solution, an SLA violation can be predicted and the evaluation phase starts. The time to violation t_viol can be computed as the time after which there will be the intersection.

During this phase, a local mitigation is enforced, if possible, depending on the non-compliant KPIs.

An estimation of t_migration is computed, and if t_viol is greater than a sensitivity window of duration s*t_migration, the violation is considered far in time and no migration must be enforced. Otherwise the migration is triggered. The s value depends on the criticality level and must be defined in the SLA.

The evaluation phase stops if the regression coefficient increases and there is no violation prediction anymore.

In the following, example algorithms for migration evaluation and decision are provided.

| | |
|---|---|
| Do_mitigation(t_viol) | // beginning of evaluation phase, triggered |
| when | // estimate_ttv returns non inf. |

{
Start_inplace_mitigation( );

| | |
|---|---|
| t_migration = fetch t_migration | // t_migration is periodically updated by |
| another | // task, we here fetch the |

```
    most recent value
    While Detection or (Prediction!=inf)
    {
```

| | |
|---|---|
| if t_viol < s*t_migration | // condition for immediate migration |

```
          {
            Trigger_migration( );
          }
```

| | |
|---|---|
| Else | // sample periodically to check if to |
| migrate | // or apply in place mitigation |

{

| | |
|---|---|
| Wait for end of t_sampling; | // can in principle be different from the |
| monitoring | //period outside the mitigation |

```
function
            Prediction = estimate_ttv(KPIs,SLA);
            Detection = SLA_violation_detection(KPIs,SLA);
        }
    }
    Stop_inplace_mitigation( );
}
Update_migration( )
{
  t_migration = estimate_migration( );
  Store t_migration
  Wait for period;
}
estimate_ttv(KPIs, SLA)
{
  For each KPI in KPIs
    {
      n = compute_number_samples(KPI);
      RC = regression_on_the_KPI(KPI,n);
      If RC < 0 //<0 for GT KPI operator, >0 for LT KPI op.
      {
            ttv_vec.append(RC / (Current − SLA_thresh));
            violated_KPIs.append(KPI)
      }
  }
```

| | |
|---|---|
| Violation_predicted = SAT_solver(SLA, violated_KPIs) | // check if the violated KPIs can |
| lead to a | // violation of the overall |

```
SLA
  If violation_predicted
  {
                ttv = min{ttv_vec | ttv belongs to a violated_KPIs} // find the set
```

| | |
|---|---|
| of KPIs | // |

```
    that lead to violation
                return ttv
  }
  Else return inf
}
```

With the above proposed migration evaluation and decision method, an SLA violation can be predicted in advance, and the time needed for mitigation (including in-place mitigation and migration) can be estimated. Further, the configuration of a migration sensitive (time) window provides a specific condition for deciding whether to carry out migration, namely that when the time to the predicted violation is less than the duration of the migration sensitive (time) window. This ensures that sufficient time for migration for mitigating the violation, in particular due to the configuration of the migration sensitive (time) window being equal to an estimated time of migration multiplied by a criticality-level aware factor. Therefore, an adaptive migration evaluation and decision method can be tailored to the specific critical level of the service: for instance, for service with a higher criticality level, a greater factor could be configured to ensure that migration could be carried out sufficiently in advance. Preferably, the criticality-level aware factor is an integer in a range of for instance 1 to 10. As a result, a most suitable migration decision for the particular service with a corresponding criticality level can be provided.

When an SLA violation is predicted in a future time, the algorithm for evaluating a migration or an in-place mitigation starts. In particular, when the time to violation is greater than the duration migration sensitive (time) window, an in-place mitigation could be carried out depending on the violated KPIs; when the time to violation is smaller than the duration of migration sensitivity (time) window a pre-emptive arrangement of the migration could be carried out.

As shown in FIG. 2 the estimation of the migration time is preferably carried out before any in-place mitigation or migration is carried out, such that it can be decided well in advance before a predicted violation, whether to carry out in-place mitigation or migration. This improves the efficiency of the mitigation and achieves to tackle the violation even before it happens.

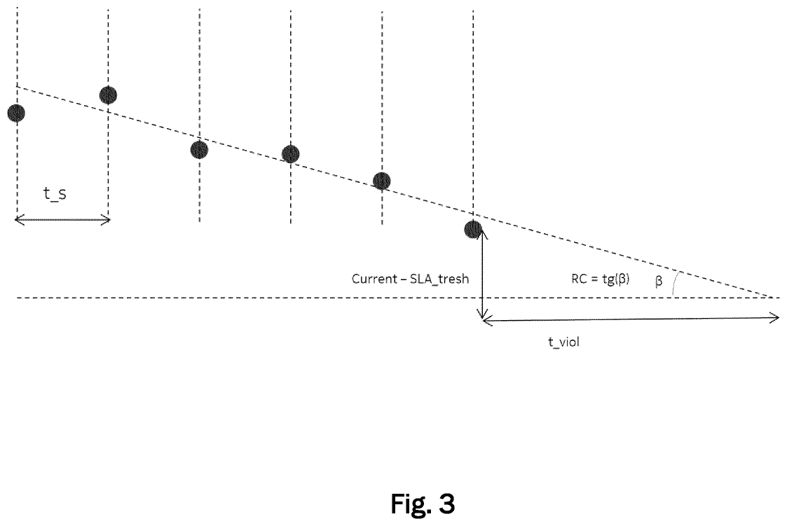

FIG. 3 shows an example embodiment of the SLA violation prediction method/algorithm: t_s represents the sampling time, and the circles are samples of one of the KPI specified in an SLA. The sequence of samples shows a decreasing trend. The horizontal dashed line represents the threshold that is deemed acceptable for a specified SLA. RC is the regression coefficient. Thanks to it, an intersection between the threshold and the trend of the actual sampled KPI can be computed. Hence, t_viol can be derived, that is the time interval from the last KPI sample to the predicted violation.

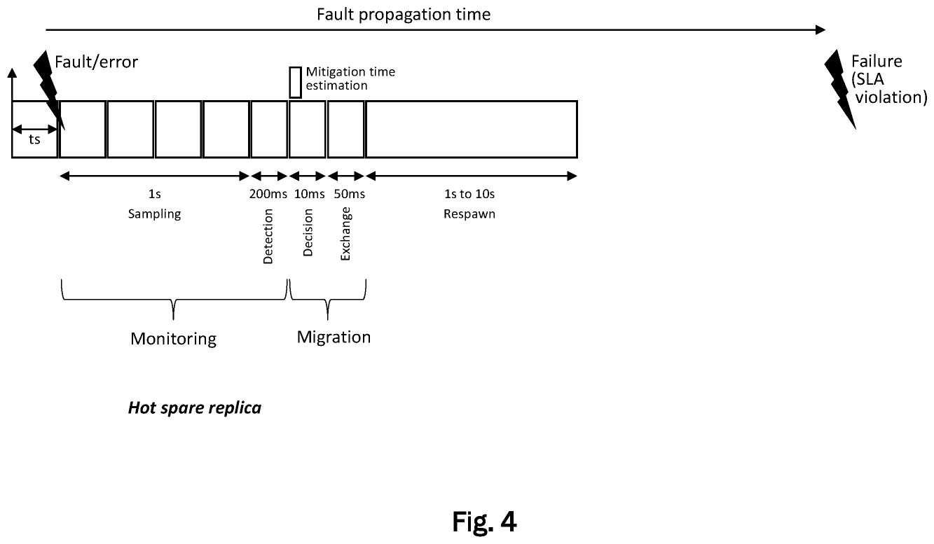

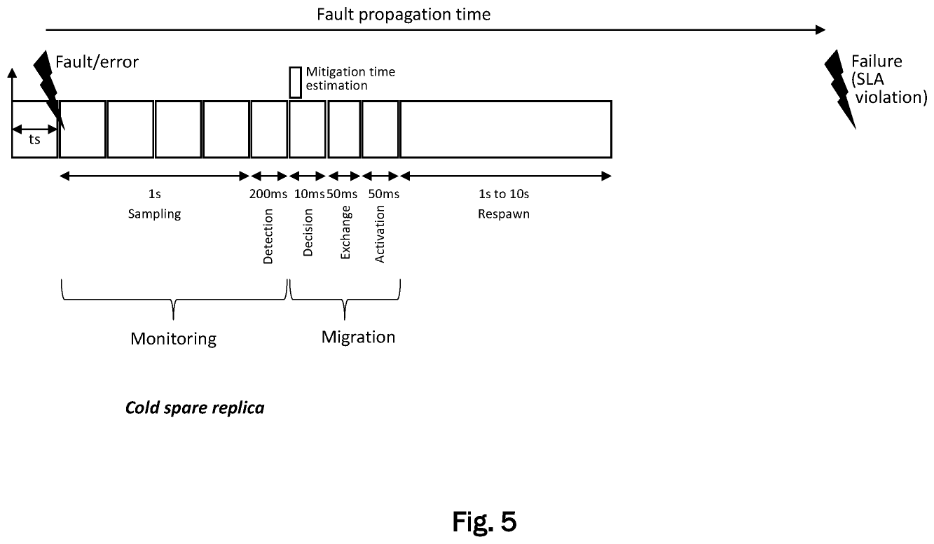

FIGS. 4 and 5 show an example estimation of the migration time for different levels of SLA criticality. Times can have major variations in a real scenario. Therein, FIG. 4 shows the estimation of the time needed for migrating the service to a hot spare replica, and FIG. 5 shows the estimation of the time needed for migrating the service to a cold spare replica. It is basic knowledge that hot replicas are active, receiving inputs and computing outputs without sending them, while cold replicas are non-active, and must be started with reserved resources.

In the following, a method for destination node selection is provided. Example algorithms are also shown.

A service characterized by an SLA of criticality level C undergoes a full mitigation workflow. The factory floor is made up of N nodes, K of which are suitable for hosting workloads with criticality at least C. Each node is described by a vector of resources ^{→}R and S vectors of features ^{→}F, where S is the number of active SLAs, i.e. SLAs admitted to the system. S different vectors are needed, since each SLA could specify specific requests, such as latency from a determined node etc., hence is not possible having a unique set of KPIs that express the capability of a node in respecting each SLA in the system. ^{→}R contains R free hardware resources of the node, like the amount of free memory, CPUs, disk, available sensors, accelerators, actuators, etc. ^{→}F contains F KPIs periodically sampled, like network latency, etc.; that express the assurance with which an SLA can be respected. This information is summarized in a single score for each SLA, that represents the capability to respect the SLA.

Nodes must be filtered basing on their free resources and capability to respect the KPIs specified in the SLA, i.e. thresholding on R and F vectors basing on the requirements. Remaining ones, suitable to host the service, must be ranked by higher score at respecting the SLA and lower migration cost. The node with the highest score is selected for the migration.

The scores are periodically updated by the KPI monitoring system.

Periodically and after a migration, a network re-optimization process is simulated to discover the optimal resource allocation. This process could involve different techniques: network slices' rearrangement, antenna tilting or repositioning.

First, k suitable nodes with enough resources are filtered out of the K, basing on ^{→}R. Nodes with a hardware utilization greater than a specified threshold are filtered out as well to prevent resource trashing. The remaining nodes are ranked by score, that are periodically updated, and a ranking for each SLA is tracked by the control plane. The final rank also contains a penalty term for the resource utilization and the migration cost. The former prevents the crowding of the best nodes, since a node with a high score for an SLA has probably high scores for other SLAs, attracting services. The latter takes into account the cost of a migration between two nodes, given by

$$cost = t\_exc + t\_download \_t \_issue .$$

In case of Resiliency SLA or higher, a penalty term for nodes that suffer from common-cause failures is subtracted as well.

If the first node in the ranking has a score greater than the current node by at least a threshold parameter, it is selected as the target node for the migration.

$${score}_{j , s} \geq {score}_{cur , s} + threshold$$

The score is computed through the equation:

$${score}_{j , s} = {\sum }_{∀ i} {w}_{i} arccot ( \frac{{F}_{des , s} [ i ] - {F}_{j , s} [ i ]}{{F}_{des , s} [ i ]} )$$

where i is the KPI index in the feature vector of the SLA s, j is one of the K nodes, and des is the desired SLA specification. w_i are the weights of the KPIs and Σ∀i(wᵢ)=1, and are different for each SLA specification.

The scores in ^{→}F respect the higher is better rule. The idea is that scores slightly worse or better than the current make a big difference, while very high or low scores have an impact independent of how much high or low the scores are.

Next, the orchestration system can try to schedule queued deployment requests, potentially preempting low priority ones.

The rearrangement of computational and network resources must be joint because one is functional to the other: the network rearrangement can be used to create dedicated channels to quicken the migration process, and node resources can be necessary to host network functions.

In the following, example algorithms for node scoring and destination node selection are shown.

```
Node_selection( )
{
  Filtered0 = Filter_out_by_criticality(All_nodes);
    Filtered1 = Filter_out_by_KPIs(Filtered0);
  Filtered2 = Filter_out_by_available_resources(Filtered1);
  For all nodes in filtered2
  {
      Migration_cost = (t_exc + t_download + t_issue)*weight;
      If SLA_level >= resiliency
        CCF_penalty = compute_common_cause_failures(node);
      Else
        CCF_penalty = 0
      Score = compute_score(KPIs, requirements);
          Overcrowding_penalty = compute_overcrowding(node,score);
      Overall_score = score − migration_cost − overcrowding_penalty − CCF_penalty;
  }
  Pick node with highest score in filtered2
}
```

//Note: the filtering function can be enforced in one step, in the algorithm is in three steps for reading clarity

```
Compute_overcrowding (score)
{
        Penalty = 0
        For all resources in \vec{ }R
        {
              if occupancy > threshold
                  Penalty += Occupancy − threshold
        }
        Return penalty*score
}
Compute_score ()
{
      ${score}_{j , s} = {\sum }_{∀ i} {w}_{i} arccot ( \frac{{F}_{des , s} [ i ] - {F}_{j , s} [ i ]}{{F}_{des , s} [ i ]} )$
}
KPIs update
```

With the above proposed node scoring and destination node selection method, a list of nodes for each SLA, being ranked on the basis of their resources and capability to meet the KPIs specified in the SLAs, is provided and constantly updated based on the mutation in the nodes and network environment, such that at each moment and in particular at the time of predicting an SLA violation, the first-ranking node with the highest score may be selected as the destination node for the migration, provided that the score of this first-ranking node is higher than the current node providing the to-be-migrated service by a pre-determined threshold value. This ensures that a most suitable node can be immediately selected once the migration decision is made. Consequently, efficiency in pre-empting the SLA violation is furthermore improved.

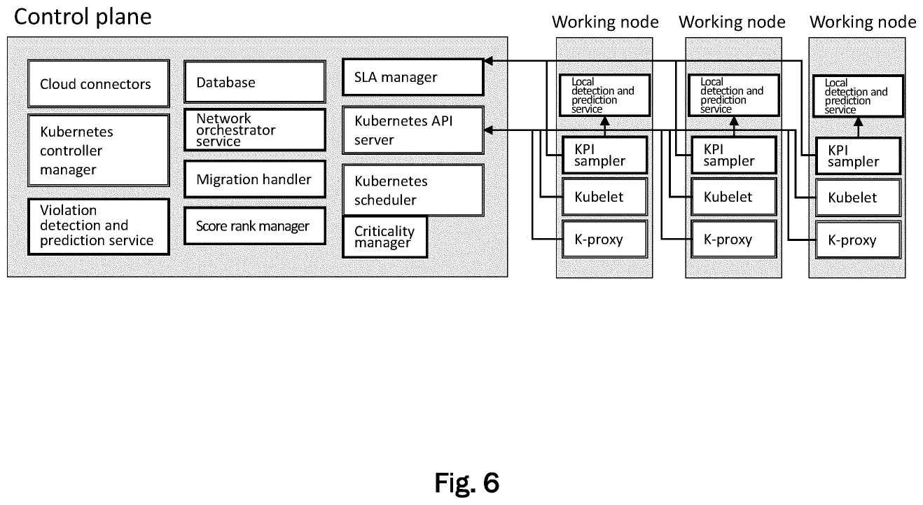

FIG. 6 provides a system view of the main components of the framework. The item enclosed in bold text frames represent the elements introduced by the present disclosure in the architecture, wherein the other elements represent basic Kubernetes components, i.e. the orchestrator took as reference.

The architecture is divided in control plane, that is the services deployed on the single or multiple master nodes controlling the cluster, and working nodes, that are the services deployed on each node of the cluster. The services in the control plane communicate with each other to manage the cluster state, while the worker nodes exchange information and commands with the control plane through the API server.

For each worker nodes some basic Kubernetes services and other additional services must be deployed, thus the worker node must be a Linux enabled machine with enough resources for these services. On the other hand, services must be designed to run with agility on embedded hardware (e.g., IoT gateways and embedded computers), thanks to an elastic design. Example worker nodes are PLC-controlled devices (like conveyor belts and other factory automation machineries), robots, AGV and AGH, as well as infrastructure network elements (e.g., IoT gateways, service routers, access points and photonic switches) and cloud instances.

In the following the main components of the architecture are described in detail.

### KPI Sampler

The device manager is in charge of:
a. Enabling data collection endpoints;
b. Collecting data from the managed system and send data to the SLA manager (in FIG. 6);
c. Compile SLA locally and program the microservices for evaluating the SLA conditions;
d. Run local network and system sounding functions;
e. Manage network connection on the managed system;
f. Perform periodic tasks (e.g., timers) and data-driven events (e.g., actions based on KPI-based predicates).

The device manager is designed to offload the mentioned tasks to the micro-services running in the cloud. To guarantee smooth operations even in case of disconnections and network outages, microservices implementing task c., d., e., and f., can be deployed locally on the device-manager node.

### SLA Manager

Several KPI samplers are managed by the SLA manager component (FIG. 6) to provide a centralized access to latest KPIs, network interfaces counters, system counters and allocated SLAs. The component is in charge of:
a. Keeping track of the current status of the managed KPI sampler instances by storing relevant data on the end point enabled, SLA active, sounding functions and other device manager active services on the relational database;
b. Enabling server-side network sounding that include one way ping, and network capacity measurements between the managed device managers and itself;
c. Store the SLAs requested and admitted to the system;
d. Compile the SLA request and decompose it in commands to create network sounding functions, data collection endpoints, notifications and actions based on the SLA KPIs. Performs checks on SLA violations based on the collected data and on the SLA, conditions specified in the SLA request.

### Score Rank Manager

The score rank manager (FIG. 6) computes periodically the scores for every node and every SLA, keeping updated the rankings in case of migration triggered.

The component is in charge of:
a. Spawning services and functions necessary to nodes' scores computation;
b. Computing scores for every node and every SLAs admitted to the system;
c. Keeping track of the ranks of the scores;
d. Evaluate possible degradations of the KPIs after a migration.

### Migration Handler

The migration handler (FIG. 6) decides when to trigger a migration of a service. The component is in charge of:
a. Evaluate the migration time for services affected by SLA violation;
b. Deciding when to trigger a migration;
c. Handling the migration of the state of the service, in case of stateful services;
d. Issuing commands for replication management of services (input spreading, output consolidation, voting management etc.), including virtual network configurations.

### Violation Detection and Prediction Service

Violation detection and prediction service (FIG. 6) executes the algorithms to predict and detect SLA violations for all SLAs, relying on collected KPIs. The component is in charge of:
a. Running the SLA violation detection and prediction algorithms on the collected KPIs;
b. Send alerts to the migration handler in case of violations;
c. Evaluate the faulty KPIs and enforce in-place mitigations;

It is worth noticing that part of the Violation detection and prediction service must also be distributed on all the nodes, analysing data of the node itself to reduce latency. This local services report anyway to the central service after the analysis.

The KPI that must be analysed in a very short time are analysed locally, otherwise they are analysed by the service in the control plane, that is logically unified but that could be physically replicated for scalability reasons.

### Network Orchestration Service

The component is the orchestrator for the programmable network. It is in charge of:
a. Managing network resources (both computational and radio resources);
b. Keep track of network channel quality through distributed network monitoring;
c. Reconfigure network slices when needed, through management of VNF;
d. Enforce interface switching for the nodes to improve the probability of respecting the SLA;
e. Configure virtual networks.

### Criticality Manager

The component is a plugin for the Kubernetes scheduler component. It is in charge of:
a. Make the Kube-scheduler aware of SLAs and criticality levels;
b. Communicating with the other introduced components, acting as a bridge;
c. Influence or override the decision of the vanilla kube-scheduler, enforcing the node selection algorithm for migration.

The criticality manager in the scheduler is in charge on taking the first of the list, check if it is available to host a new application, and enforce this decision. If the first node in the list is not suitable to host a new application (e.g., since the node is too full), the criticality manager takes the second node from the list and so on, until a suitable destination node is found. For instance, if the first-ranking node (i.e., the node having the highest score among the plurality of nodes) has a highest score that is greater than said target node by at least a pre-determined threshold value, said first-ranking node is selected as the destination node; otherwise, the other nodes are to be checked in an order of decreasing score, until a suitable destination node (e.g., with a score that is greater than said target node by at least a pre-determined threshold value) is found and selected.

### Feedback to Factory Floor Service

The service communicates with the SLA violation detection and prediction to give feedbacks to factory floor when needed to prevent major outages. The component is in charge of:
a. Tracking all the possible capability reduction/functionality exclusion in the floor for the equipment;
b. Choose the right countermeasure basing on the information received by the SLA violation manager;
c. Send the commands to the factory floor to enforce the countermeasure;

In the following, an example SLA specification is shown in Table 1.

TABLE 1
Example of a SLA specification

```
{
  “kpis”: [
    {
```

| | |
|---|---|
| “kpi”:“latency”, | // type of the KPI or sounding function |
| | // to consider; it can be any of the |
| | // collected KPI or supported sounding function |
| “operator”:“LTE”, | // logical operator to use in the evaluation of the |
| | // requirement; can assume values as GTE (>=), |

GT(>),

| | |
|---|---|
| | // EQ(=), LT (<) LTE (<=) |
| “threshold”:66.66, | // threshold used to compute the logical predicate |
| “num_samples”:5, | // number of samples to consider |
| “statistical_operator”:“PERCENTILE”, | // statistical function to compute on |
| “percentile_value”:95, | // the collected samples (5 samples in |
| | // this example) |
| “destinations”:[ | // destination(s) where to compute the |
| “10.1.0.45” | // requirement from |

],

| | |
|---|---|
| “network_interface”:“wlan0”, | // name of the KPI to collect |
| “period”:“2ms”, | // sampling period |
| “weight”:“3” | // weight, used for the score |

```
    },
    {
      “kpi”:“bitrate”,
      “operator”:“GTE”,
      “threshold”:20000000,
      “num_samples”:20,
      “statistical_operator”:“MEAN”,
```

| | |
|---|---|
| “traffic_direction”:“BIDIRECTIONAL”, | // to be applied in uplink and downlink |
| “destinations”:[ | // destination(s) where to compute the |
| “10.1.0.45” | // requirement from; in this case the |
| ], | // requirements will be computed on uplink |
| | // and downlink given that the traffic_class |
| | // direction is set to BIDIRECTIONAL |

```
      “network_interface”:“wlan0”,
      “period”:“2ms”,
      “weight”:“3”
    },
  ],
  “device_id”:{
    “device_serial”:“serial”,
    “device_model”:“model”,
    “device_family”:“family”
  },
  “position”:{
    “latitude”:12312.33,
    “longitude”:123213.33,
    “altitude”:12312.23
  },
```

| | |
|---|---|
| “associative_operator”:“AND”, | // it is the association operator needed to evaluate |

the

// SLA condition (in this case latency and bitrate

are checked

// if the Boolean function is more complex, these

elements

// are contained into a hierarchical structured

list, each

// with its own Boolean operator

```
  “anomaly_detection_algorithm”:“RANDOM_CUT_FOREST”,
  “anomaly_prediction_algorithm”:“TRUE”,
  “on_violation_send”:“REST”, //REST,MQTT,KAFKA,NONE
  “end_point_violation_handler”:“http://endpoint”,
  “end_point_violation_payload”:“MEASUREMENT_DUMP”
```

| | |
|---|---|
| “criticality”:“HIGH_AVAILABILITY” | // SLA criticality level: PERF, HIGH_AVAILABILITY, |
| | // RESILIENCY OF SAFETY |

}

### Use Cases Examples

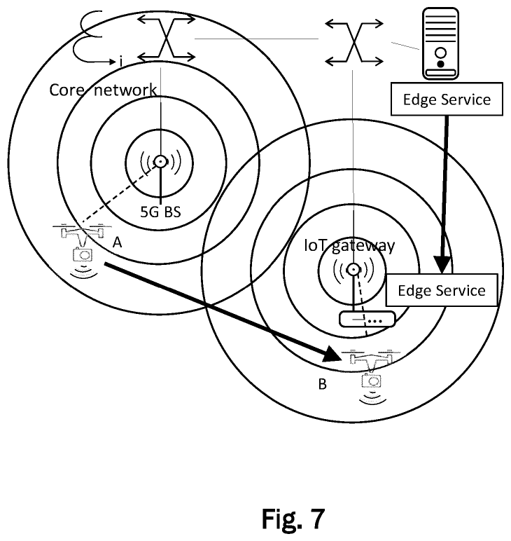

In the following it is provided use case examples for each SLA criticality level, as shown with FIGS. 7 to 10.

As shown in FIG. 7, as an example for the Performance SLA, imagine a drone streaming images to an edge service for some non-critical inventory application. Since the drone is moving, the quality of the network channel changes during time, and when the drone arrives far away (point B in FIG. 7) from the 5G base station to which it is connected, the latency of the communication increases and the response time of the service does not respect anymore the SLA, hence an SLA violation is predicted in advance, risking a wrong storage accounting. Moving the edge service to the IoT gateway itself and switching the connection to Wi-Fi reduces the response time. The orchestration system reserve resources on the gateway to spawn the service, and when it is up the migration is enforced, and the network channel switched. The 5G network is rearranged to release network resources allotted to the drone.

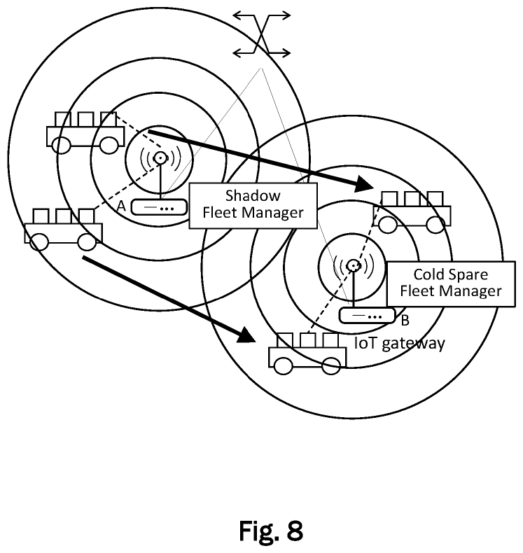

As shown in FIG. 8, for the High-availability SLA, imagine a fleet manager controlling two AGV (Automated Guided Vehicles). These robots are used in Industry for carriage of goods, for example, and they move through infrared sensors, along a path decided point-by-point by a fleet manager in the edge cloud. The service cannot afford downtime of seconds, since this would mean robots moving blindly for meters, possibly colliding and going out of control. When the robots move away from the base station to which they are connected, to keep a low response time also the fleet manager must be migrated to the approaching base station. In this way, a shadow service is created, that follows the AGVs all along their path. A cold spare replica can be placed in the approaching base station, since the path of the AGVs is known thanks to the process information. When the network handoff is enforced, and the robots are connected to the gateway B, the cold replica is activated and the former fleet manager is migrated somewhere else.

In case the cold service is in a wrong place and cannot be replaced in time by the migration time estimation, the feedback to the floor can reduce the movement speed of AGVs, or stopping them, saving time for the migration. Periodically the KPIs are evaluated and the spare service is migrated to the alleged approaching base station, to ensure the lowest downtime and SLA violation in case of migration.

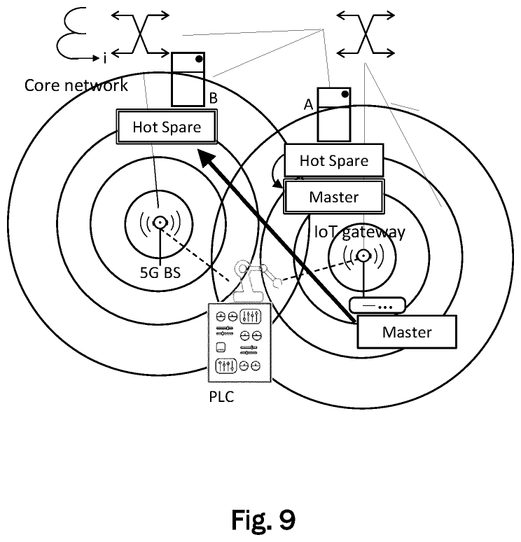

As shown in FIG. 9, for the Resiliency SLA, the replica on the gateway acts as master, sending values to the actuator, the other (on server A) is a hot spare. The actuator receives control values through a Wi-Fi link, but it is also 5G enabled. The connection to the gateway becomes degraded due to moving obstacles in the factory.

To guarantee SLA despite the failures, avoiding service outages at all, the orchestration system reconfigures the hot replicas to take over the role of master replica and provide the service seamlessly.

The master role is passed to the hot spare service on server A in figure, relying on a 5G channel. After a joint rearrangement of network and computing resources, the hot spare replica is respawned on the edge server B in figure, that is able to guarantee a suitable response time for the SLA.

The two servers have little or no common cause failures, so there is little risk to have a common failure to both of the replicas.

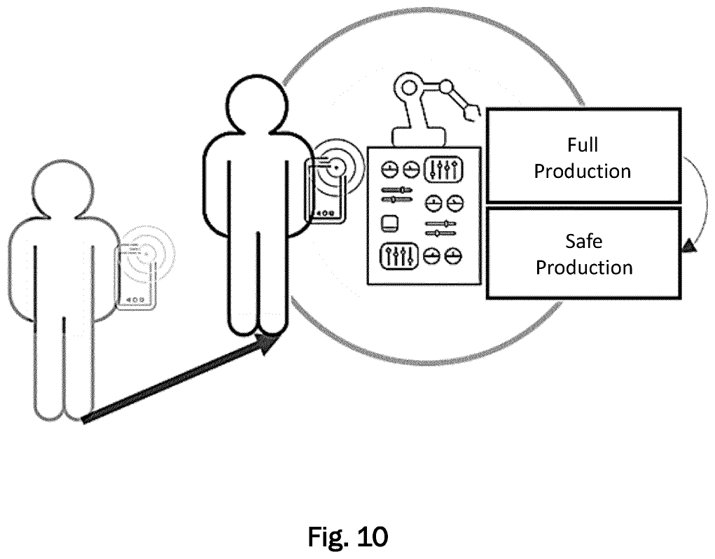

As shown in FIG. 10, for the Safety SLA, imagine a moving robot that handles potentially harmful tools. A human operator gets near to check some displayed information, or just because it is crossing the path of the robot. Despite there is a human-free zone on the floor signaled by LEDs, the worker doesn't see it and enters the zone.

The presence of a person is detected, and immediately the Full production container is replaced by a Safe production container, whose behaviour depends on the actions that the robot is currently taking, getting to the nearest safe state.

These use cases fall into three generic contexts: a static environment context, in which machinery is static, but redundancy is needed for dependability purposes, to cope with failures; a mobile environment, in which the redundancy is needed to cope with a continuously changing environment, to adapt to it; and finally a reconfigurable environment, in which machineries are semi-static, but are periodically moved and reconfigured to change the factory production goals and rent the production lines for short times like a few weeks. An example for the first scenario is a factory with software divided in microservices deployed on the edge cloud. An example for the second scenario is a factory that makes massive use of AGVs of different sizes and drones, already spread out in current factories. An example for the third scenario, described by the vision of Industry 4.0, is a factory of Surface-Mount Technology (SMT) pipelines, that are periodically rented to customers that own Intellectual Properties (IPs), but are not able to physically produce chips, since it is a very costly activity. The pipelines must be reconfigured, moved and rearranged depending on the aim and the customer.

In the following, it is explained how the proposed infrastructure management system of SLA-driven allocation of software components could be used for managing the components of a 5G core network.

There can be identified four scenarios, that are one the natural evolution of the previous.
1. Core all in cloud
2. Cloud partially in cloud and partially on edge devices
3. Core on customer premises with some user application in cloud
4. Everything on premises

The core completely in cloud is the default architecture for 5G application without particular latency or criticality requirements. In the case the SLA-driven allocation of components can be used to manage the high quantity of cloud nodes, choosing between the most reliable node to deploy essential components. When a new deployment request with a latency-critical requirement arrives, it becomes necessary to move part of the core network on the edge to reduce the communication latency. In this case, the User Plane Function (UPF), or other parts of the User Plane can be brought to the edge cloud, even on embedded devices, that could also be devices with radio capabilities as well. In this way, the communication latency is reduced to the minimum. Indeed, the SLA-driven orchestrator deems as suitable nodes to respect the latency specified in the SLA only the ones near to the User Equipment (UE).

If the request issued has not only latency-sensitive requirements, but also dependability requirements such as a reliability or availability greater than the internet connection to the cloud, the core network must be moved on the local customer premises. In this case, for example, the deployment request for the core network components would specify a criticality that cannot be satisfied by the nodes in cloud, hence only the nodes on the edge would be chosen as suitable to host the network functions. However, a few services can be still deployed on a remote cloud if they don't have latency or criticality requirements, taking advantage of the scalability of the cloud resources.

A different case is when all the network must benefit of criticality, security and safety guarantees. In this case a remote connection with the cloud could not be allowed, and the entire infrastructure, including the 5G core network, must be deployed on the customer premises. In this scenario, the core function are deployed on the edge servers in premises, while the user plane function can be deployed as close as possible to the User Equipment, even on embedded devices.

Across the scenarios, the orchestration system plays an essential role because the evolution between one scenario and another is completely seamless and driven by the deployment requests and their programmed SLAs. The orchestrator adaptively modifies the deployment scenarios to respect the SLAs.

The present disclosure provides a unified programmable framework to enforce SLAs using cloud native technologies (e.g., Kubernetes and Dockers). The key objective of the platform in this disclosure is to be able to manage computing resources with respect to the networking, reliability and safety requirements individually expressed for each connected application. This falls under the umbrella of software orchestration and automation for 6G, in the following aspects:
1. Fog computing and extreme edge
2. Disaggregated RAN (DU/CU)
3. 6G Decentralized Paas for vertical applications
4. Specialized 6G services
5. Deep Slicing
6. Intent-based and SLA-driven networking

The contribution in this disclosure extends network slicing capabilities to (e.g., performance, latency and reliability enforcement) to any connected computing system (including network core services) enabling Unified multi-stakeholder orchestration that will allow for a layered approach to 6G service and network management with SLA-driven end-to-end service orchestration on top of capability orchestration per domain, including the unified RAN-Core. The SLA-driven end-to-end service orchestration vision, of which this disclosure is a central piece, will also enable the concept of Deep slicing to extend slice-specific composition of microservices and assignment of dedicated hardware/software stacks to RAN to will increase the level of specialization and efficiency of 6G networks by defining and enforcing use-case/UE specific SLAs. This will enable the option of flexible functional placement taking into account service requirements and multiple factors such as cloud capabilities, hardware accelerators and network/computer utilization, among other network-specific KPIs.

In summary, it is proposed in accordance with the present disclosure predicting a failure and migrating the workload somewhere else before the violation, with improved efficiency in deciding whether (a pre-choice between in-place mitigation and migration), when (well in advance before the failure actually happens), and where (the most suitable destination node for meeting the SLA requirements) to migrate and also in the performance of the migration, taking into consideration the criticality level of the service, such that the mitigation is adaptive. It is further proposed to perform KPI-based SLA composition and allocation of network service across different access networks.

The violation prediction and decision of target node could be implemented in different ways, following the same basic approach as proposed in the present disclosure.

Simulations of future scenarios to identify failures could be used instead of the KPI monitoring, and simulations to predict the migration time, which information could be used to trigger a migration as specified in the previous sections in the present disclosure.

Instead of a ranking of nodes, a graph could also be used to evaluate the conditions for optimal migration on the fly, still using the same approach proposed in the present disclosure.

Instead of criticality level of the application, other related parameter could also be used to differentiate the approach, without changing the nature of the differentiated countermeasure policy based on the risk of a violation, with risk defined as probability of failure times severity of consequences, as proposed in the present disclosure.

### LIST OF ABBREVIATIONS

AGV: autonomous guided Vehicle
AMH: automated materials handling
SLA: Service Level Agreement
KPI: Key Performance Indicator
OT: Operation Technology
PLC: Programmable logic controller

As has been noted above, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1-20. (canceled)

21. An apparatus for controlling a plurality of working nodes on which applications providing services are running, said apparatus comprising a network orchestration unit, a detection and prediction unit and a migration handling unit, wherein:
said network orchestration unit is configured to monitor said plurality of working nodes and configure network resources for said plurality of working nodes;
said detection and prediction unit is configured to detect or predict a Service Level Agreement, SLA, violation at a target node comprised in said plurality of working nodes; and
said migration handling unit is configured to trigger migration of a target service provided by a target application running on said target node to a destination node, in a case where a time to violation related to said predicted or detected SLA violation is less than a duration of a migration sensitive window related to said migration.

22. The apparatus according to claim 21, wherein said migration handling unit is configured to trigger said migration, in a case where said time to violation is larger than a duration of an in-place mitigation window related to in-place mitigation of said detected or predicted SLA violation.

23. The apparatus according to claim 21, wherein said migration handling unit is configured to trigger in-place mitigation of said detected or predicted SLA violation, in a case where said time to violation is less than a duration of an in-place mitigation window related to said in-place mitigation.

24. The apparatus according to claim 21, wherein said duration of said migration sensitive window equals to an estimated migration time multiplied by a criticality factor, and the criticality factor is related to a critical level of said target service.

25. The apparatus according to claim 24, wherein a value of said criticality factor increases for critical levels in the order of a first critical level, a second critical level, a third critical level and a fourth critical level, and the apparatus comprises a criticality managing unit configured to record and output said critical levels.

26. The apparatus according to claim 25, wherein for a first criticality level:
said network orchestration unit is configured to generate, at said destination node, a replica for said target service, preferably at the time of detecting or predicting said SLA violation; and
said migration handling unit is configured to migrate said target service to said destination node.

27. The apparatus according to claim 25, wherein for a second critical level:
said network orchestration unit is configured to generate, at said destination node, a cold spare replica for said target service; and
said migration handling unit is configured to activate said cold spare replica, preferably at the time of detecting or predicting an SLA violation at said destination node, and to migrate said target service from said target node to a node comprised in said plurality of nodes that is different from said destination node.

28. The apparatus according to claim 27, wherein said network orchestration unit is configured to: in a case where said destination node is not able to mitigate said SLA violation within said estimated migration time, send a delay instruction to said target node for delaying said target service.

29. The apparatus according to claim 25, wherein said network orchestration unit is configured to, for a third critical level:
configure said target node as a master node for said target service and generate, at said destination node, a hot spare replica for said target service, if an SLA violation is not yet detected or predicted at said target node; and
configure said destination node as the master node for said target service and configure said target node as the hot spare replica, if an SLA violation is detected or predicted.

30. The apparatus according to claim 25, wherein said network orchestration unit is configured to, for a fourth critical level:
in a case of said detected SLA violation being a violation of a safe state, replace said application running on said target node with a safe container for returning to the safe state.

31. The apparatus according to claim 21, wherein said SLA comprises mathematical and statistical relations between Key Performance Indicators, KPIs, and numeric KPI thresholds specified for said plurality of nodes.

32. The apparatus according to claim 21, wherein said migration handling unit is configured to obtain said time to violation for said target node on the basis of a regression model established for sampled KPIs related to said target node, wherein said time to violation is computed as the time after said regression model intersects with one or more of KPI thresholds specified for said target node.

33. The apparatus according to claim 21, wherein said prediction and detection unit is configured to predict and/or detect said SLA violation based on sampled values of KPIs of said plurality of nodes.

34. The apparatus according to claim 21, further comprising a score ranking unit:
configured to calculate a score for each of said plurality of nodes and SLAs related to said each node; rank said plurality of nodes based on calculated scores; and
said criticality managing unit is configured to check said plurality of scored nodes starting from the highest ranking node in an order of decreasing score, determine if a node has a score that is greater than said target node by at least a pre-determined threshold value, and select said node as the destination node.

35. The apparatus according to claim 21, wherein the apparatus is configured for managing factory related networking and computing resources and/or for managing a production line to deliver commands on-time to moving, and/or static, and/or semi-static industrial components.

36. A method, carried out by an apparatus for controlling a plurality of working nodes on which applications providing services are running, said apparatus comprising a network orchestration unit, a detection and prediction unit and a migration handling unit, wherein the method comprises:
monitoring, by said network orchestration unit, said plurality of working nodes and configure network resources for said plurality of working nodes;
detecting or predicting, by said detection and prediction unit, a Service Level Agreement, SLA, violation at a target node comprised in said plurality of working nodes; and
triggering, by said migration handling unit, migration of a target service provided by a target application running on said target node to a destination node, in a case where a time to violation related to said predicted or detected SLA violation is less than a duration of a migration sensitive window related to said migration.

37. A system comprising an apparatus according to claim 21, and a plurality of working nodes controlled by said apparatus, wherein each node comprises a KPI sampling unit configured to collect sampled KPI values for KPIs specified in SLAs for said each node, and to provide said collected values to said apparatus.

38. The system according to claim 37, wherein said apparatus and said plurality of working nodes are configured in the Cloud.
